(19) United States
(12) Patent Application Publication
(10) Pub. No.: US 2007/0019553 A1
(43) Pub. Date: Jan. 25, 2007

(54) Minimizing Padding for Voice Over Internet Protocol-Type Traffic Over Radio Link Control

(75) Inventors: Mats Sagfors, Kyrkslatt (FI); Johan Torsner, Masaby (FI); Stefan Wager, Esbo (FI)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 11/425,447

(22) Filed: Jun. 21, 2006

Related U.S. Application Data
(60) Provisional application No. 60/700,327, filed on Jul. 19, 2005.

(51) Int. Cl. H04L 12/26

(52) U.S. Cl. 370/236; 370/238

(57) ABSTRACT

A radio access network node (24) comprises protocol data unit (PDU) formation logic (36); a PDU buffer (38); a concatenation timer (40); and a buffer readout mechanism (39). The protocol data unit (PDU) formation logic (36) serves, e.g., for segmenting incoming service data units (SDUs) to form protocol data unit (PDUs). The PDU buffer (38) stores one or more PDUs. The buffer readout mechanism (39) controls readout of contents of the PDU buffer (38). For example, when contents of a PDU in the PDU buffer (38) has not reach a predetermined fill level, the buffer readout mechanism (39) uses the concatenation timer for determining a delay for readout of the PDU from the PDU buffer (38). The delay provides opportunity for at least a portion of a yet-arrived SDU to be included in the PDU prior to readout of the PDU from the PDU buffer (38), and thereby reduce padding in an outgoing PDU.

This application claims the benefit and priority of U.S. Provisional Patent Application 60/700,327 filed Jul. 19, 2005, which is incorporated herein by reference in its entirety.

### BACKGROUND

I. Technical Field

This invention presents technology for minimizing the amount of padding when transmitting VoIP or similar traffic over a radio link employing segmentation and concatenation, e.g. the 3G link layer RLC. Reducing padding results in increased network capacity.

II. Related Art and Other Considerations

The Wideband Code Division Multiple Access (WCDMA) radio link control (RLC) protocol includes functions for segmentation and concatenation of higher layer “packets” into RLC protocol data units (PDUs). Typically, the RLC is operated with a discrete number of allowed RLC PDU sizes. Segmentation involves a large higher-layer packet being divided or “segmented” into smaller RLC PDUs. Concatenation facilitates the possibility of sending (parts of) several higher layer packets in one RLC PDU. Concatenation reduces the need of padding if several higher-layer PDUs are queued for transmission, in case each packet does not fit perfectly into the RLC PDUs. Segmentation and concatenation are possible in both unacknowledged mode (UM) and acknowledge mode (AM) WCDMA RLC.

Improved layer two (L2) solutions for voice over internet protocol (VoIP) are currently being discussed in 3GPP. See, for example, R2-0509693, “L2 Optimizations for VoIP” (Qualcomm, 3GPP TSG-RAN WG2 meeting 46 bis, 4-8 Apr. 2005) and R2-041645, “L2 Considerations for VoIP Support” (Qualcomm, RAN2#43), both of which are incorporated herein by reference.

Consider the case of a VoIP service being mapped over a link-layer protocol like WCDMA RLC, which deploys concatenation. In current Radio Link Control protocol (RLC) implementations, the radio link control typically segments incoming Service Data Units (SDUs) into equally sized so-called Protocol Data Units (PDU), which commonly are configured to carry a 40 byte payload.

Assume that ROHC header compression is used on the application level to minimize the IP overhead transmitted over the link, and that the speech codec transmits voice frames of size 159 bits in 20 ms intervals (7.95 kbps AMR). This will produce RLC SDUs of a size around 24 bytes. The exact size may fluctuate a bit depending on the ROHC implementation.

A typical feature of VoIP-like traffic is a fairly well predictable inter-arrival time of packets. In the example above, RLC SDUs will arrive to the RLC with an (average) inter-arrival time of 20 ms. Unless there is any queuing at the RLC layer, the RLC SDUs will be segmented into RLC PDUs directly upon arrival. The twenty four byte SDU will fill only part of the RLC PDU and the rest will be filled with a one byte length indicator to indicate the end of the SDU, and then fifteen bytes of padding. In this scenario, the overall padding added to the traffic stream is around thirty five percent. Thus, the present practice is very inefficient, because thirty five percent of the transmission capacity will be spent on transmitting obsolete bits (e.g., padding). This is particularly problematic for HSDPA-like shared transport channel realizations, where the queue-buildup takes place in the radio base station (RBS) at times of congestion. This means that a large fraction of the resources are also wasted at times when the radio resources are scarce, since a large fraction of the resources are spent on padding.

The existing RLC protocol supports concatenation, e.g., part(s) of the following SDU may be concatenated into the RLC PDU carrying the end of the last SDU, thus avoiding the use of padding. However, this concatentation requires that the next SDU be available in the radio network controller (RNC) node. But realistically, in the case of a VoIP service with 20 ms (or more) between SDUs, the RNC buffer will be empty most of the time, assuming low or moderate load on the air interface. This is especially the case when using the HS-DSCH channel, for which the scheduling buffer resides in the NodeB (e.g., radio base station or RBS), and each RLC SDU is typically forwarded to the Node B directly upon arrival.

What is needed, therefore, and an object of the present invention, are apparatus, methods, and techniques for reducing the amount of padding and thereby increase network capacity and/or efficiency.

### BRIEF SUMMARY

A radio access network node comprises protocol data unit (PDU) formation logic; a PDU buffer; a concatenation timer; and a buffer readout mechanism. The protocol data unit (PDU) formation logic serves, e.g., for segmenting incoming service data units (SDUs) to form protocol data unit (PDUs). The PDU buffer stores one or more PDUs. The buffer readout mechanism controls readout of contents of the PDU buffer. For example, when contents of a PDU in the PDU buffer has not reach a predetermined fill level, the buffer readout mechanism uses the concatenation timer for determining a delay for readout of the PDU from the PDU buffer. The delay provides opportunity for at least a portion of a yet-arrived SDU to be included in the PDU prior to readout of the PDU from the PDU buffer, and thereby reduce padding in an outgoing PDU.

The buffer readout mechanism delays readout of a PDU from the PDU buffer until either (1) the contents of the PDU in the buffer has reached the predetermined fill level, or (2) a predetermined time interval (maintained by the concatenation timer) has expired.

In an example implementation, non-limiting implementation, the SDUs are twenty four byte voice over Internet Protocol (VoIP) packets which arrive with twenty millisecond inter-arrival time; forty octets of payload are allowed in each PDU; and the predetermined time delay is set between twenty milliseconds and forty milliseconds

In terms of predetermined fill level, in an example embodiment the buffer readout mechanism delays read out of the PDU from the PDU buffer by the predetermined time interval if an extent of padding that would occur upon transmission of current contents of the PDU in the PDU buffer is not less than a threshold. In one example implementation, the threshold is ten percent of a length of the PDU size.

Another aspect of the technology concerns a method of operating a radio access network node. The method includes the basic, example steps of segmenting incoming service data units (SDUs) to form protocol data unit (PDUs); storing one or more PDUs in a PDU buffer; and delaying readout of a PDU of the PDU buffer when contents of the PDU in the PDU buffer has not reached a predetermined fill level. The delay provides opportunity for at least a portion of a yet-arrived SDU to be included in the PDU prior to readout of the PDU from the PDU buffer, and thereby reduce padding in an outgoing PDU. The method can comprise delaying the readout of the PDU from the PDU buffer until either (1) the contents of the PDU in the buffer has reached the predetermined fill level, or (2) a predetermined time interval has expired.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a control node which performs RLC protocol concatenation.

FIG. 2A and FIG. 2B are flowcharts showing example steps of an example embodiment.

FIG. 3A-FIG. 3C are diagrammatic views showing a sequence of three packets arriving at a node which implements RLC protocol concatentation.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

According to one example mode, the last PDU in the RNC segmentation buffer is delayed for a certain amount of time, guarded by a timer, hereafter referred to (only for sake of convenience) as the concatenation timer 40. By delaying the last PDU in the RNC until the next SDU arrives, the PDU can be filled up with parts of this next SDU instead of padding. This eliminates the use of padding on this link and thus increases the capacity of the system. The tradeoff is, of course, an increased delay. A threshold λ is used to set the acceptable percentage of padding in outgoing PDUs. PDUs exceeding this level are stored until the concatenation timer expires.

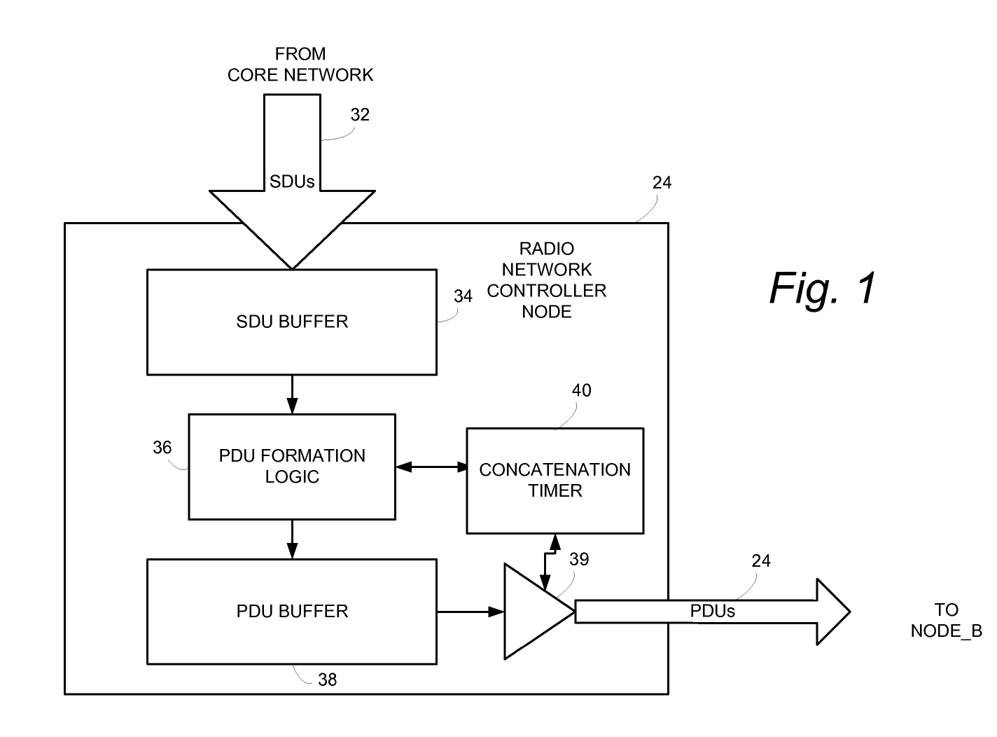

As an example, non-limiting embodiment of implementation, FIG. 1 illustrates a control node, such as a radio network controller (RNC) 24, which (as indicated by arrow 32) receives SDUs, e.g., from a core network. The RNC 24 comprises, among numerous other unillustrated constituent elements, an (optional) SDU reception buffer 34; PDU formation logic 36; PDU buffer 38; PDU buffer readout mechanism 39; and concatenation timer 40.

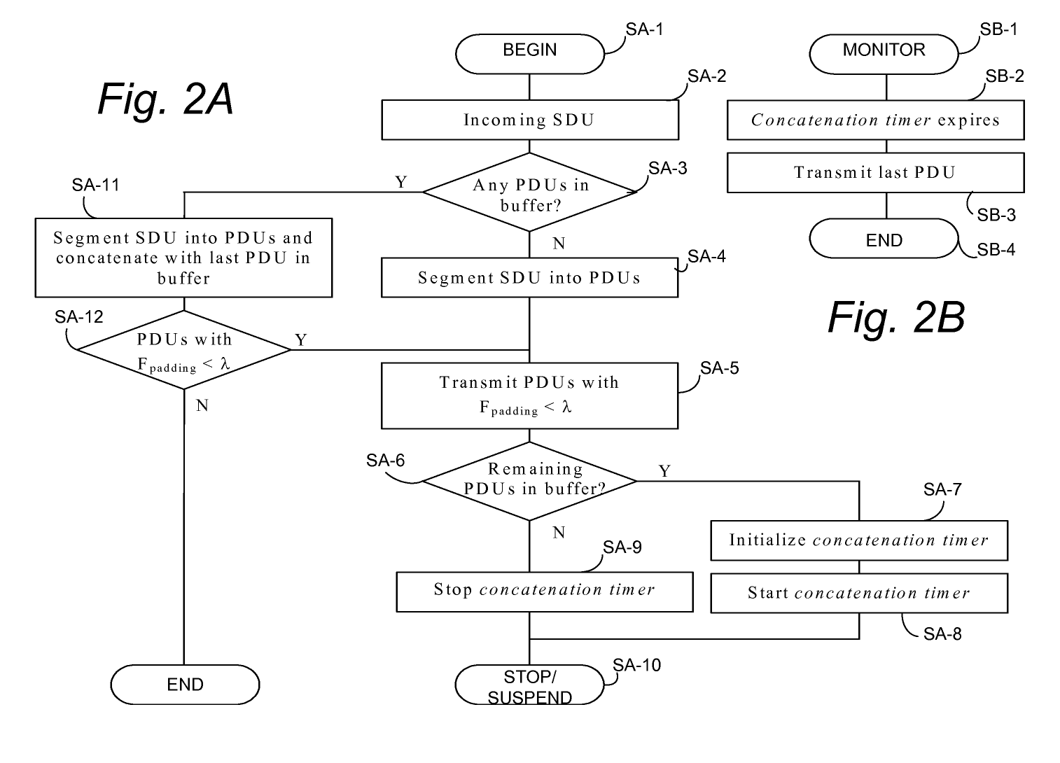

FIG. 2A and FIG. 2B are flowcharts showing representative, non-limiting, example steps of an example embodiment. The steps of FIG. 2A and FIG. 2B can be executed instantaneously or substantially instantaneously. 2A particularly shows example steps for handing incoming SDUs, while FIG. 2B shows example steps performed upon expiration of the concatenation timer. The two events that trigger operation are (1) an incoming SDU (step SA-1) or (2) expiration of the concatenation timer (step SB-2). Step SA-2 reflects receipt and processing of the incoming SDU. As step SA-3, a check is made (e.g., by PDU formation logic 36) whether there are any PDUs already in PDU buffer 38. If not, as step SA-4 the incoming SDU is segmented (e.g., by PDU formation logic 36) into PDU(s), and the PDU(s) are stored in PDU buffer 38. If a PDU is full, or if the extent of padding that would result if the current contents (of a PDU in PDU buffer 38) were now transmitted is less than the threshold λ, then as step SA-5 that PDU is readout of buffer 38 (e.g., by PDU buffer readout mechanism 39), e.g., to the NodeB. Then, as step SA-6, a check is made whether there are any remaining PDUs in PDU buffer 38 which have a padding ratio higher than the threshold λ. If the check result is affirmative, as step SA-7 the concatenation timer 40 is initialized to zero and then started as step SA-8. After starting of concatenation timer 40 at step SA-8, the SDU processing routine of FIG. 2A is temporarily ended or suspended (step SA-10). If the check result from step SA7 was negative, the concatenation timer is stopped at step SA9, and then the SDU processing routine of FIG. 2A is temporarily ended or suspended (step SA-10)

If at step SA-4 it is determined, upon receipt of an incoming SDU, that PDUs already reside in PDU buffer 38, then as step SA-11 the incoming SDU is segmented into PDUs and concatenated with the last PDU already in PDU buffer 38. As step SA-12 a check is made whether PDU buffer 38 contained any PDUs with an extent of padding less than the threshold λ. If the determination at step SA-12 is positive, step SA-5 and ensuing steps are performed (e.g., step SA-6, step SA-7, step and SA-8, or (as appropriate) step SA-9). If the determination at step SA-12 is negative, then the SDU processing routine of FIG. 2A is temporarily ended or suspended (step SA-13).

As reflected by step SB-1, the concatenation timer 40 is appropriately monitored. Should the concatenation timer 40 expire, an interrupt or other indication is received (step SB-2). In view of expiration of concatenation timer 40, as step SB-3 the last PDU in PDU buffer 38 is readout, and the timer monitoring routine of FIG. 2B is temporarily concluded.

Thus, when contents of a PDU in the PDU buffer has not reach a predetermined fill level, the buffer readout mechanism uses the concatenation timer for determining a delay for readout of the PDU from the PDU buffer. The delay provides opportunity for at least a portion of a yet-arrived SDU to be included in the PDU prior to readout of the PDU from the PDU buffer, and thereby reduce padding in an outgoing PDU. The buffer readout mechanism delays readout of a PDU from the PDU buffer until either (1) the contents of the PDU in the buffer has reached the predetermined fill level (step SA-5), or (2) a predetermined time interval (maintained by the concatenation timer) has expired (step SB-3).

To cause as little extra delay as possible, the concatenation timer (e.g., concatenation timer 40) may be adapted to the inter-arrival time of incoming SDUs. This may be done either by continuous filtered measurements on incoming traffic or by reading QoS attributes like the guaranteed bit rate and frame size, if available. The concatenation timer can be set slightly larger than the inter-arrival time of incoming SDUs, to cover possible jitter. This jitter may also be measured.

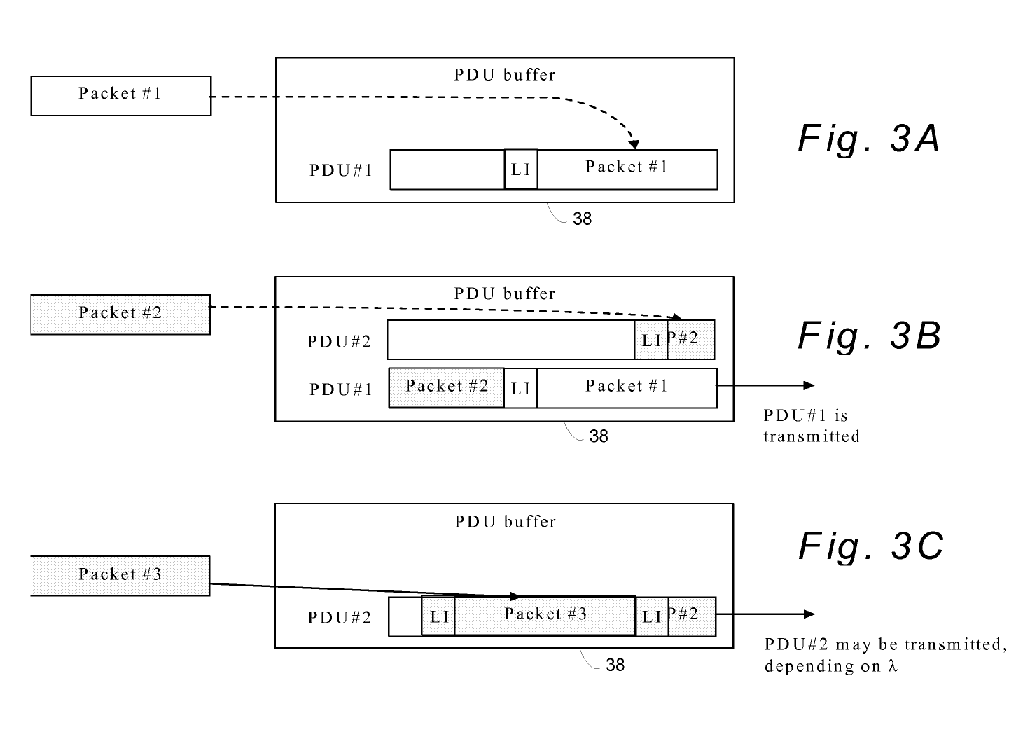

Consider an example case illustrated in the time sequence of FIG. 3A-FIG. 3C. In the example case, VoIP packets of 24 bytes arrive at PDU buffer 38 with 20 ms inter-arrival time to the RLC, where the RLC PDU allows for 40 octets of payload in each PDU (excluding the length indicator). FIG. 3A shows a first packet (Packet #1) arriving (step 2A-2) and being stored in PDU buffer 38. It is assumed, for sake of this example, that the acceptable padding percentage is set to 10%. Since Packet #1 is the only packet in PDU buffer 38 and thus PDU buffer 38 has only 24 bytes, for Packet #1 it is determined at step SA-5 that the percent or ratio of padding to entire PDU length exceeds the threshold λ. Consequently, Packet #1 remains in PDU buffer 38 (step SA-6) and the concatenation timer 40 is both initialized (step SA-7) and started (step SA-8). Preferably, the concatenation timer is initialized/set to a value larger than 20 ms, but less than 40 ms in this example.

FIG. 3B shows arrival of a second packet (Packet #2) Upon arrival of the second packet (Packet #2), it is determined at step SA-3 that a PDU already resides in PDU buffer 38, i.e., Packet #1 is already in the first PDU of buffer 38. Accordingly, as step SA-11 the newly arriving packet (Packet #2) is segmented into two RLC PDUs in 38. As such, a first PDU of PDU buffer 38 includes the first VoIP packet, a one byte length indicator (LI) and fifteen bytes of the second VoIP packet. But nine bytes of the second packet did not fit into the first RLC PDU of PDU buffer 38, and consequently are stored in a second PDU position of PDU buffer 38 as illustrated in FIG. 3B.

The first PDU of PDU buffer 38 is readout in accordance with step SA-5, as shown in FIG. 3B. However, since it is determined at step SA-6 that the percentage of padding in the second PDU of PDU buffer 38 (as shown in FIG. 3B) is above the threshold X, both step SA-7 and step SA-8 are performed. At step SA-7, the concatenation timer 40 is re-initialized and at step SA-8 the concatenation timer 40 is started again.

At the reception of the “third” packet (Packet #3) shown in FIG. 3C, as step SA-11 the third packet is concatenated with the stored nine bytes of Packet #2 into the sole occupied PDU (PDU #2) of PDU buffer 38. In this case, the occupancy (in octets) of PDU #2 is: 9+24=33 octets plus 2 length indicators, and thus is less than the RLC PDU payload size. Depending on the level of “optimization” (delay versus capacity), PDU #2 can now either be transmitted with seven octets of padding, or stored for concatenation with yet another VoIP packet. With a threshold of 10%, it is determined at step SA-12 that PDU #2 should still remain in PDU buffer 38. Note that in this case, concatenation timer 40 is not restarted, since no PDU was transmitted. The concatenation timer 40 is always PDU specific. With a higher threshold, like e.g. 20%, PDU #2 of FIG. 3C would be transmitted, causing more padding, but smaller delay.

For the downlink, the proposed functionality can be implemented in the RNC without changes to the standard. The uplink does require a standardized solution.

The techniques described herein provide a mechanism for tradeoff between delay performance and capacity for VoIP-like services. When active, the techniques reduce the amount of padding on the radio link, which will increase capacity in the system.

Readout of the packets from PDU buffer 38 and from the node which hosts PDU buffer 38 can be to any suitable device or transmission line. Furthermore, the concept of “readout” can include moving PDUs from PDU buffer 38 to a suitable transmission unit for conveying the PDUs out of the node or device which hosts the PDU buffer 38.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. It is to be understood that the invention is not to be limited to the disclosed embodiment, but on the contrary, is intended to cover various modifications and equivalent arrangements.

What is claimed is:

1. A radio access network node comprising:
protocol data unit (PDU) formation logic for segmenting incoming service data units (SDUs) to form protocol data unit (PDUs);
a PDU buffer for storing one or more PDUs;
a concatenation timer;
a buffer readout mechanism for controlling readout of a PDU in the PDU buffer, the buffer readout mechanism being arranged whereby when contents of a PDU in the PDU buffer has not reach a predetermined fill level, the buffer readout mechanism uses the concatenation timer for determining a delay for readout of the PDU from the PDU buffer for providing opportunity for at least a portion of a yet-arrived SDU to be included in the PDU prior to readout of the PDU from the PDU buffer, and thereby reduce padding in an outgoing PDU.

2. The node of claim 1, wherein the buffer readout mechanism delays readout of a PDU from the PDU buffer until either (1) the contents of the PDU in the buffer has reached the predetermined fill level, or (2) a predetermined time interval has expired.

3. The node of claim 2, wherein the predetermined time interval is adjusted for inter-arrival time of incoming SDUs.

4. The node of claim 3, wherein the predetermined time interval is adjusted for inter-arrival time of incoming SDUs by continuously filtered measurements or incoming traffic or by reading quality of service (QoS) attributes.

5. The node of claim 2, wherein the SDUs are twenty four byte voice over Internet Protocol (VoIP) packets which arrive with twenty millisecond inter-arrival time, wherein forty octets of payload are allowed in each PDU, and wherein the predetermined time interval is set between twenty milliseconds and forty milliseconds.

6. The node of claim 1, wherein the buffer readout mechanism delays read out of the PDU buffer if an extent of padding that would occur upon transmission of current contents of the PDU in the PDU buffer is not less than a threshold.

7. The node of claim 6, wherein the threshold is ten percent of a length of the PDU

8. The node of claim 1, wherein the concatenation timer is reset upon readout of a PDU from the buffer.

9. A method of operating a radio access network node comprising:
segmenting incoming service data units (SDUs) to form protocol data unit (PDUs);
storing one or more PDUs in a PDU buffer;
delaying readout of a PDU of the PDU buffer when contents of the PDU in the PDU buffer has not reached a predetermined fill level, thereby providing opportunity for at least a portion of a yet-arrived SDU to be included in the PDU prior to readout of the PDU from the PDU buffer, and thereby reduce padding in an outgoing PDU.

10. The method of claim 9, further comprising delaying the readout of the PDU from the PDU buffer until either (1) the contents of the PDU in the buffer has reached the predetermined fill level, or (2) a predetermined time interval has expired.

11. The method of claim 10, further comprising adjusting the predetermined time interval for inter-arrival time of incoming SDUs.

12. The method of claim 10, further comprising adjusting the predetermined time interval for inter-arrival time of incoming SDUs by continuously filtered measurements or incoming traffic or by reading quality of service (QoS) attributes.

13. The method of claim 10, wherein the SDUs are twenty four byte voice over Internet Protocol (VoIP) packets which arrive with twenty millisecond inter-arrival time, further comprising:
allowing forty octets of payload in each PDU;
setting the predetermined time delay between twenty milliseconds and forty milliseconds.

14. The method of claim 9, further comprising delaying readout of the PDU buffer if an extent of padding that would occur upon transmission of current contents of the PDU buffer is not less than a threshold.

15. The method of claim 14, wherein the threshold is ten percent of a length of the PDU size.

16. The method of claim 9, further comprising resetting the concatenation timer upon readout of a PDU from the buffer.
